(19) United States
(12) Patent Application Publication
(10) Pub. No.: US 2005/0068789 A1
(43) Pub. Date: Mar. 31, 2005

(54) [Illumination Device for Handheld Remote Control Keypads]

(75) Inventor: Arthur D. Bauer, Southington, CT (US)

Correspondence Address: ARTHUR D. BAUER, 1408 EAST STREET, SOUTHINGTON, CT, 06489, US

(73) Assignee: Arthur D. Bauer, Southington, CT (US)

(21) Appl. No.: 10/605,364

(22) Filed: Sep. 25, 2003

(51) Int. Cl. F21V 7/04

(52) U.S. Cl. 362/555

(57) ABSTRACT

A fiber optic illumination device for handheld remote controls is presented. In accordance with the present invention, the device of the present invention takes advantage of technology readily available and uses it to provide illumination to remote control keypads. The device of the present invention uses fiber optics and bright Light Emitting Diodes (LEDs) for illumination of handheld remote control keypads. Handheld remote controls are often used to control televisions, stereos, and other electronics found in most homes. The device of the present invention includes a housing assembly to locate and enclose a switch, a conductive spring wire, (2) 3 volt lithium coin cell batteries, an LED, an optical medium, a guide, and an elastic band. The combination of which allows for a compact device to provide illumination of handheld remote control keypads.

### BACKGROUND OF INVENTION

The present invention relates to illumination devices. More particularly, the present invention relates to a fiber optic illumination device used to provide illumination of handheld remote control keypads.

Handheld remote controls are infrared (IR) devices used to control televisions, stereos, and other electronics found in most homes. A majority of remote controls do not provide any illumination of the keypad. This makes it difficult to locate buttons on the keypad in the dark. Some handheld remote controls are equipped with keypads that glow in the dark. However, an aftermarket device that provides illumination of handheld remote control keypads does not exist.

It is recognized that there are numerous ways to achieve illumination. Many are detailed in the prior art. Prior art suggests a need for an independently powered handheld remote control keypad illumination device. However, devices illustrated in prior art provide illumination by either reflective means or directly by positioning the light source in close proximity to the keypad. Prior art (U.S. Pat. No. 6,050,696 to Radley) describes a remote control illuminating device with a light source positioned directly above the keypad. In addition, prior art (U.S. Pat. No. 4,905,127 to Kaminski) describes a remote control illuminator that uses a combination light and reflector to illuminate the keypad. In both prior art examples cited, the choice to place the light source in close proximity to the keypad makes the handheld remote control difficult to operate. This suggests a need for a smaller more compact innovative design.

### SUMMARY OF INVENTION

The above-discussed and other drawbacks and deficiencies of the prior art are overcome or alleviated by the device of the present invention. The device of the present invention introduces different components that offer an advantage over the prior art. The use of fiber optics in the device of the present invention allow the light source to be located remotely away from the keypad allowing the handheld remote control to be operated as originally intended. Light Emitting Diodes (LEDs) are used in the device of the present invention and offer a significant increase in brightness over traditional incandescent light bulbs. The brightness of the LED provides sufficient illumination to the keypad, through fiber optics connected to an LED located in a remotely located housing. The remotely located housing eliminates the need to enclose a light source in the proximity of the keypad as was the case with prior art. The LED is powered by two 3 volt lithium coin cell batteries. Energizer No. CR1616 coin cell batteries are typical 3 volt lithium coin cell batteries used in the device of the present invention. The small size of the lithium coin cell batteries contribute to the compact size of the housing.

The size of the housing compliments the size of typical handheld remote controls. The reduced size of the housing and the selection of fiber optics to deliver illumination to the keypad are required for ease of use and for greater acceptability of the device of the present invention. The housing and remaining components of the device of the present invention attach to the handheld remote control by using a combination of self adhesive foam tape and a tensioned elastic band.

### BRIEF DESCRIPTION OF DRAWINGS

FIG. 1 is a perspective view of a typical handheld remote control.

FIG. 2 is a perspective view of the guide of the device of the present invention.

FIG. 3 is a right side view of the guide of the device of the present invention.

FIG. 4 is a perspective view of the housing assembly of the device of the present invention.

FIG. 5 is a perspective view of the device of the present invention, including housing assembly and guide, as it is attached to a typical handheld remote control.

FIG. 6 is a bottom view of the device of the present invention, including housing assembly and guide, as it is attached to a typical handheld remote control.

FIG. 7A is an exploded perspective view of the housing assembly of the device of the present invention. FIG. 7B is an unexploded perspective view of the housing assembly of the device of the present invention.

FIG. 8A is a perspective view of the coin cell battery used in the device of the present invention illustrating the top cathode (+) surface and the cylindrical cathode surface.

FIG. 8B is a perspective view of the coin cell battery used in the device of the present invention illustrating the anode (−) surface.

FIG. 9 is a circuit diagram of the circuit that is used to power the LED used in the device of the present invention.

FIG. 10A is a top view of the housing assembly of the device of the present invention with the top cover removed to illustrate the location and position of the switch and conductive spring wire when the circuit is open and not supplying power to the LED. The conductive spring wire is not in contact with the cylindrical cathode surface of the coin cell battery. In addition, the LED and how it is connected to both coin cell batteries is illustrated. FIG. 10B is a detail view illustrating the relative position of the LED and the plastic optical fiber bundle.

FIG. 11A is a top perspective view of the switch used in the device of the present invention. FIG. 11B is a bottom perspective view of the switch used in the device of the present invention.

FIG. 12 is a perspective view of the bottom cover of the housing assembly used in the device of the present invention illustrating internal features.

FIG. 13 is a perspective view of the top cover of the housing assembly of the device of the present invention illustrating internal features.

FIG. 14 is a bottom view of the housing assembly of the device of the present invention with the bottom cover removed to illustrate the location and position of the elastic band in top cover. In addition, the position of the switch and conductive spring wire when the circuit is closed and is supplying power to the LED is illustrated. The conductive spring wire is in contact with the cylindrical cathode surface of the coin cell battery.

FIG. 15 is a perspective view of the bottom cover of the housing assembly of the device of the present invention illustrating external features.

FIG. 16 is a perspective view of the top cover of the housing assembly of the device of the present invention illustrating external features.

FIG. 17A is a perspective view of the flexible plastic optical fiber bundle used in the device of the present invention. FIG. 17B is a perspective end view detailing the plurality of individual plastic optical fibers.

FIG. 18A is a perspective view of a flexible single plastic optical fiber. FIG. 18B is a perspective end view illustrating the single core construction.

FIG. 19A is a perspective assembly view of a flexible plastic optical fiber bundle encased in a shrink wrapped assembly with a flexible wire. FIG. 19B is a perspective end view detailing the components of the assembly.

FIG. 20A is a perspective assembly view of a flexible plastic optical fiber bundle encased in a flexible sheath. FIG. 20B is a perspective end view detailing the components of the assembly.

FIG. 21A is an exploded perspective assembly view of a fiber ribbon and guide assembly. FIG. 21B is an unexploded view of the fiber ribbon and guide assembly.

FIG. 22A is a perspective assembly view of a pivotal guide mounted to a fixed base. FIG. 23B depicts a top view of the pivotal guide positioned at a random angle.

### DETAILED DESCRIPTION

The present invention discloses a method and apparatus for an illumination device for lighting the keypad of handheld remote controls using plastic optical fiber. The plastic optical fiber is configured so that an end is positioned to provide illumination to the handheld remote control keypad.

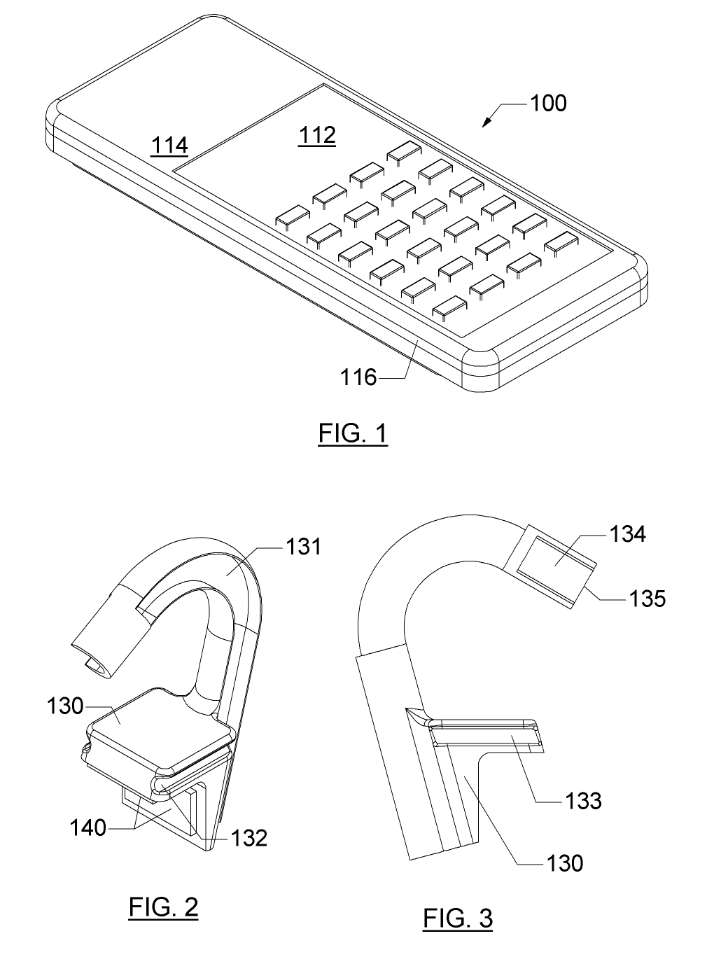

Referring to FIG. 1. A handheld remote control is generally shown at 100 with keypad 112, top surface 114, and side surface 116.

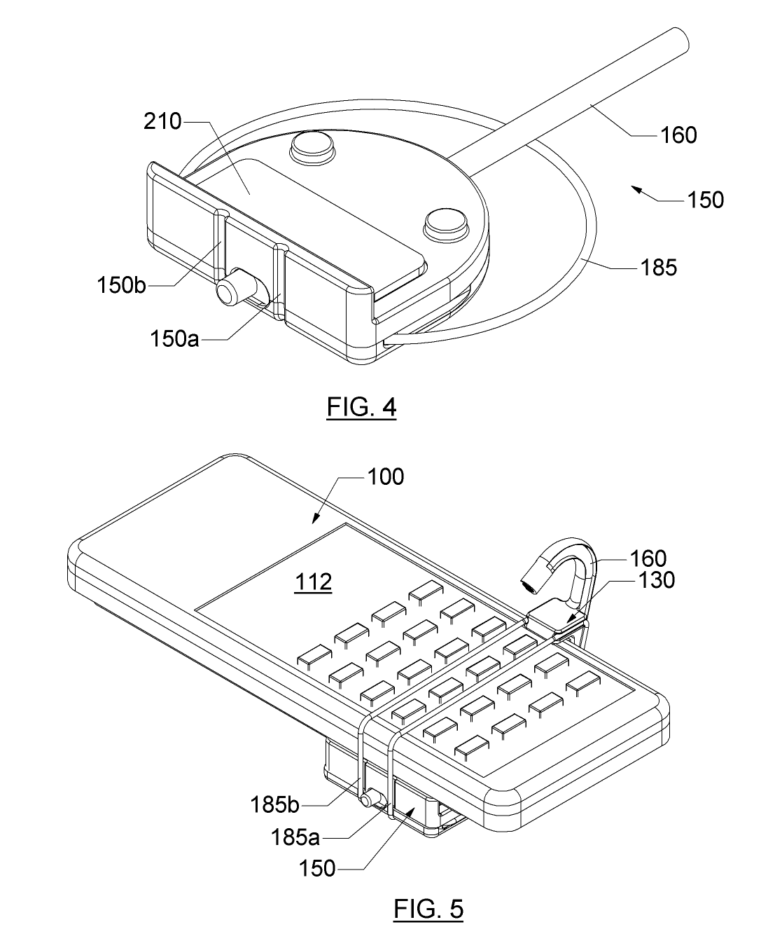

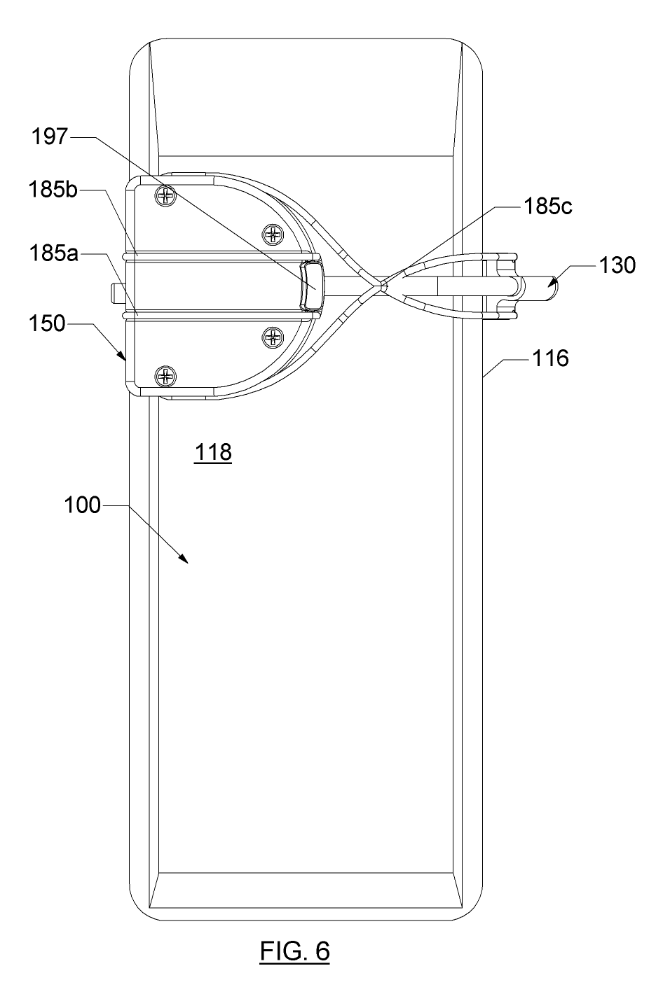

Referring to FIGS. 2, 3, 4, 5, and 6. Guide 130 is initially secured to top surface 114 and side surface 116 of handheld remote control 100 using adhesive foam tape 140. Housing assembly 150 is then secured to bottom surface 118 of handheld remote control 100 using adhesive foam tape 210. Flexible plastic optical fiber bundle 160 is then fitted into curved channel 131 of guide 130 and retained in place by surface 134 of guide 130. Additional length of flexible plastic optical fiber 160 is then trimmed off at end face 135 of guide 130. Elastic band 185 is then stretched over the top of guide 130 before parallel elastic members 185a and 185b are disposed in set of parallel grooves 132 and 133 located in guide 130. Prior to being stretched, elastic band 185 is rotated 180°, creating a crossover point 185c. The motion of rotating elastic band 185, and stretching over guide 130 directs otherwise parallel elastic members 185a and 185b into a non-parallel configuration before and after crossover point 185c. This non-parallel configuration of elastic members 185a and 185b forces elastic band 185 into set of parallel grooves 132 and 133 located in guide 130. The looped and stretched elastic band 185 is then secured to housing assembly 150 by wrapping stretched elastic band 185 over keypad 112, into set of parallel grooves 150a and 150b in housing assembly 150 and securing elastic band 185 under plastic tab 197. Stretching elastic band 185 around handheld remote control 100 through guide 130 and around housing assembly 150 ensures the device of the present invention is securely attached to handheld remote control 100.

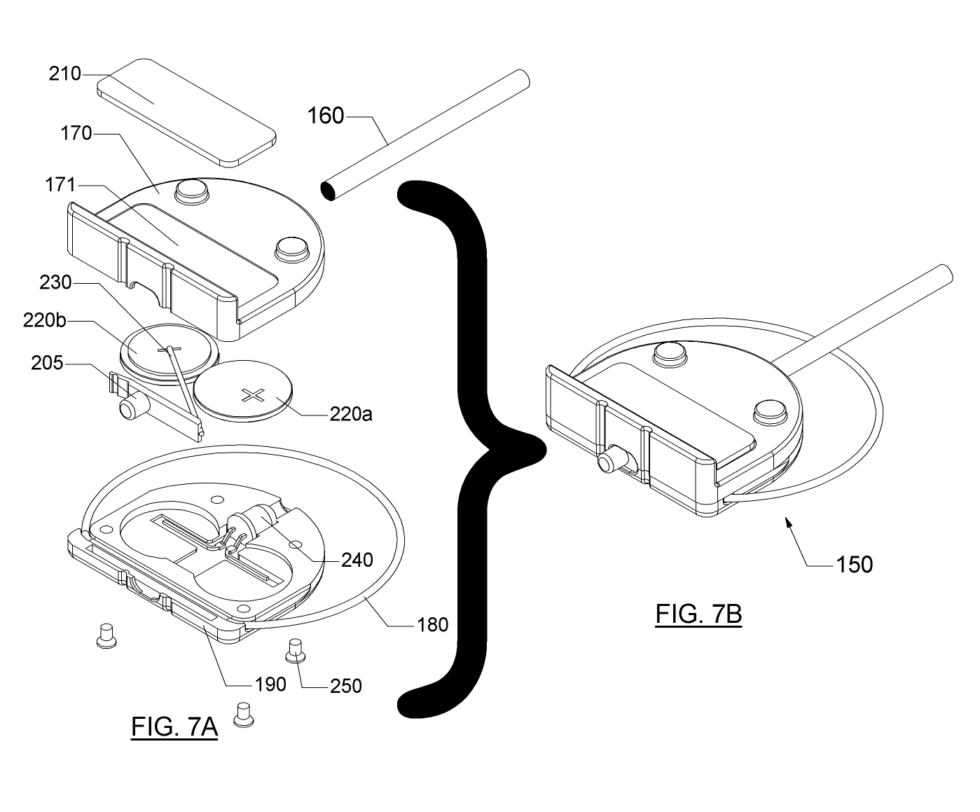

Referring to FIGS. 7A-B. Components in housing assembly 150 are shown. Top cover 190 is secured to bottom cover 170 using (4) metal screws 250. Components contained within housing assembly 150 are 3 volt lithium coin cell batteries 220a and 220b, elastic band 180, conductive spring wire 230, switch 205, LED 240, and flexible plastic optical fiber bundle 160. Adhesive foam tape 210 is secured to surface 171 of bottom cover 170.

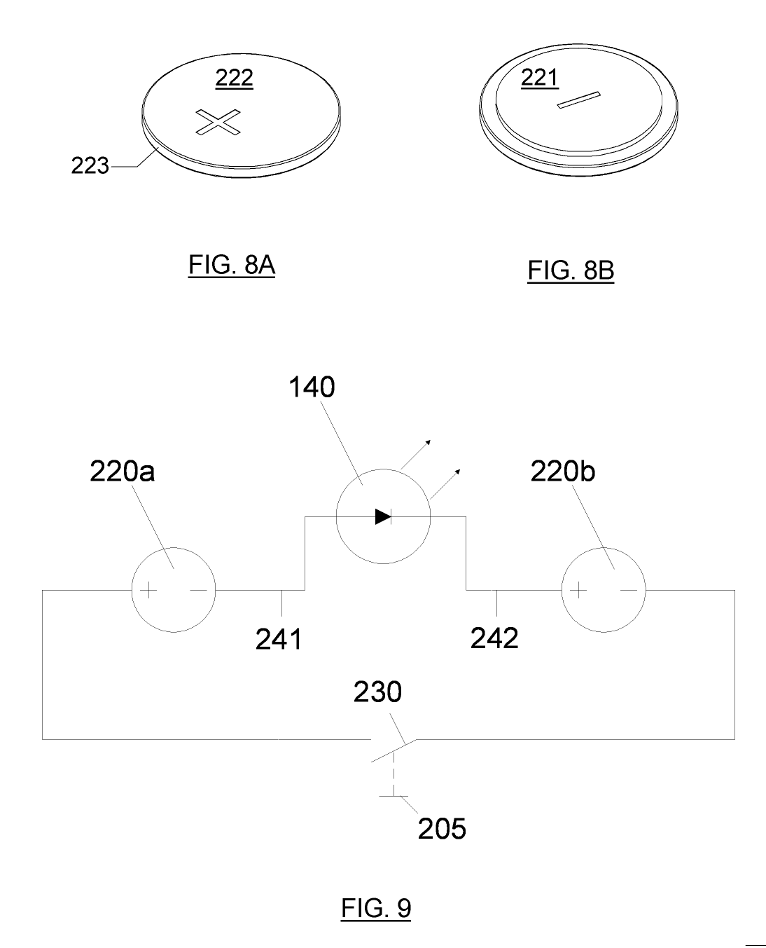

Referring to FIGS. 8A-B. 3 volt lithium coin cell batteries 220a and 220b with flat anode surface 221, flat cathode surface 222, and cylindrical cathode surface 223 are depicted. Flat cathode surface 222 and cylindrical cathode surface 223 form a common cathode.

Referring to FIG. 9. An electrical circuit diagram depicts the interconnection between switch 205, 3 volt lithium coin cell battery 220a, 3 volt lithium coin cell battery 220b, LED 240, and conductive spring wire 230 that is necessary to achieve illumination. Anode lead 241 and cathode lead 242 of LED 240 are also depicted.

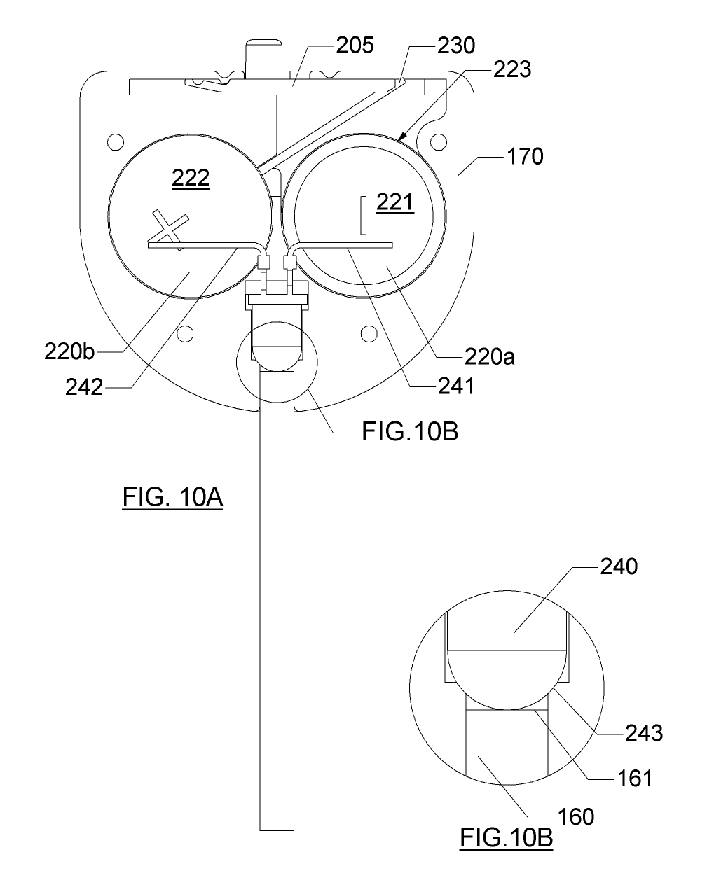

Referring to FIGS. 10A. Switch 205, 3 volt lithium coin cell battery 220a, 3 volt lithium coin cell battery 220b, LED 240, and conductive spring wire 230 are shown physically disposed in bottom cover 170. Anode lead 241 of LED 240 is permanently connected to flat anode surface 221 of 3 volt lithium coin cell battery 220a. Cathode lead 242 of LED 240 is permanently connected to flat cathode surface 222 of 3 volt lithium coin cell battery 220b. Switch 205 is in the “off” position. Conductive spring wire 230 is in a straight configuration connected to switch 205. Conductive spring wire 230 and cylindrical cathode surface 223 of 3 volt lithium coin cell battery 220a are separated by a small distance.

Referring to FIG. 10B. Domed surface 243 of LED 240 makes contact with near end 161 of flexible plastic optical fiber bundle 160. Light from LED 240 is directed into flexible plastic optical fiber bundle 160 when switch 205 is moved to the “on” position and LED 240 is illuminated.

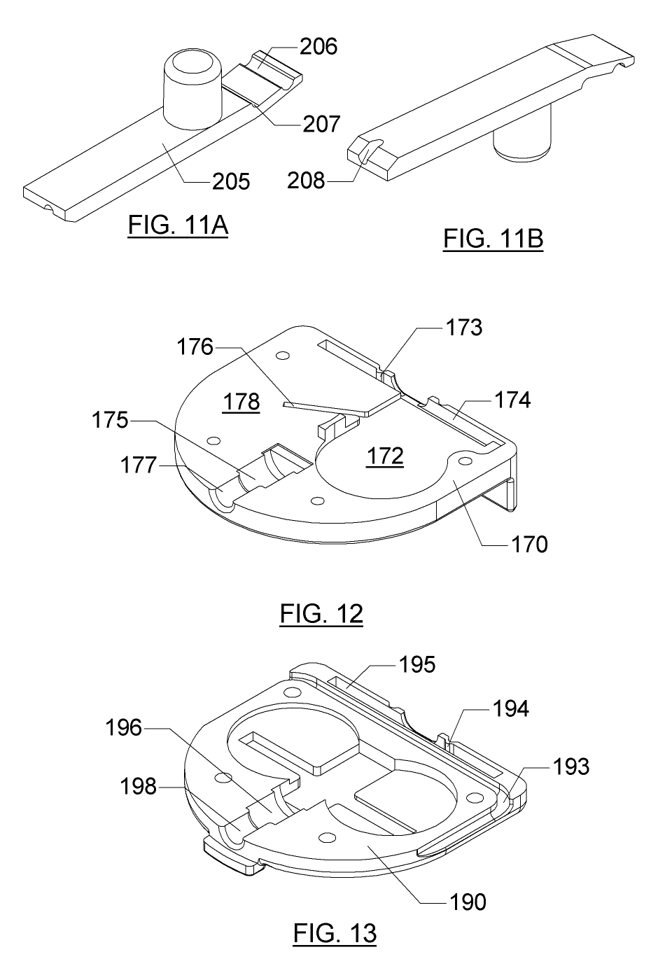

Referring to FIGS. 11A-B, 12 and 13. Circular surface 173 located in groove 174 of bottom cover 170 and circular surface 194 located in groove 195 of top cover 190 are concentric when bottom cover 170 and top cover 190 are assembled and become concentric with circular surface 206 when switch 205 in moved to the “on” position and become concentric with circular surface 207 when switch 205 is moved to the “off” position. The “on” and “off” positions are retained until changed by the user of the handheld remote control. Groove 174 in bottom cover 170 and groove 195 in top cover additionally function as a guide for switch 205. The LED is disposed in cylindrical cavity 175 of bottom cover 170 and cylindrical cavity 196 of top cover 190. The Flexible plastic optical fiber bundle is disposed in cylindrical cavity 177 of bottom cover 170 and cylindrical cavity 198 of top cover 190. Surface 172 and surface 178 of bottom cover 170 are separated by a distance to allow contact of the conductive spring wire with the cylindrical cathode surface of the coin cell battery when the switch is moved to the “on” position. Groove 176 in bottom cover 190 is used to partially contain the conductive spring wire.

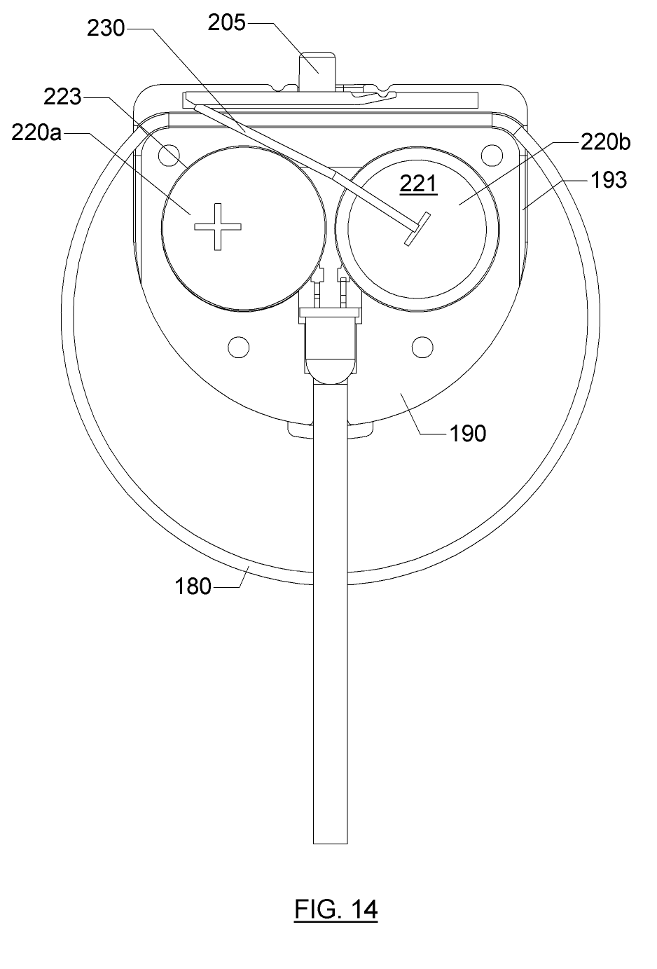

Referring to FIG. 14. Conductive spring wire 230 is permanently connected to flat anode surface 221 of coin cell battery 220b. Switch 205 is in the “on” position. Conductive spring wire 230 is deflected and forced into contact with cylindrical cathode surface 223 of coin cell battery 220a by switch 205. Elastic band 185 is disposed in molded groove 193 in top cover 190.

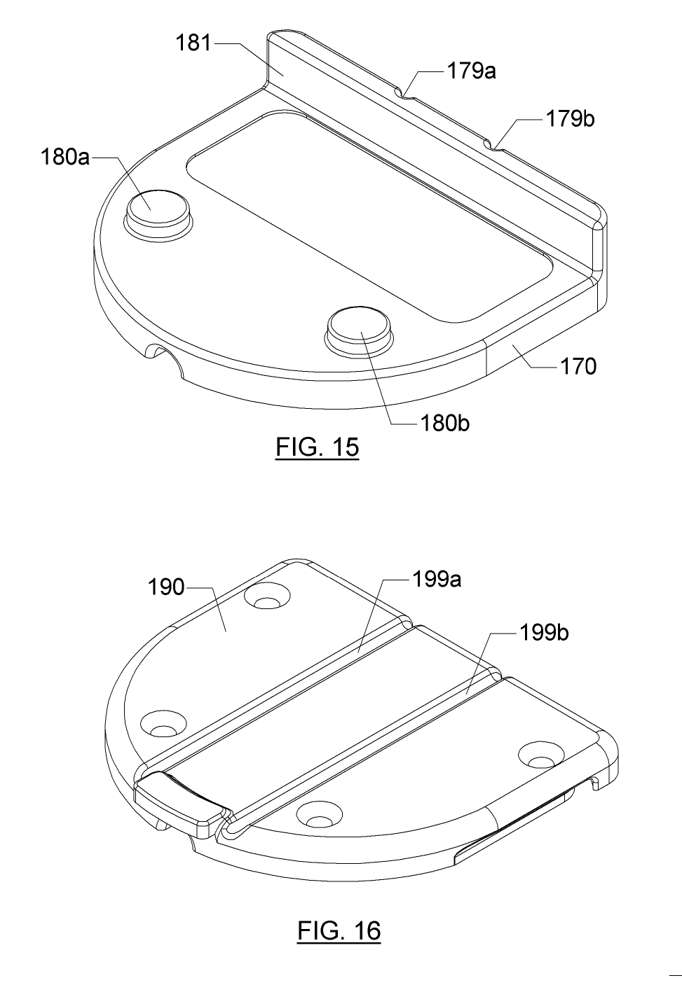

Referring to FIGS. 15 and 16. Pedestals 180a and 180b on bottom cover 170 reduce the amount of movement of the housing assembly during operation. Molded lip 181 on bottom cover 170 extends lengthwise and is used to position the housing assembly on the left or right side surface of the handheld remote control. Parallel sets of grooves 199a and 199b on top cover 190 and parallel sets of grooves 179a and 179b on bottom cover 170 retain the stretched elastic band during final assembly of the device of the present invention to handheld remote controls.

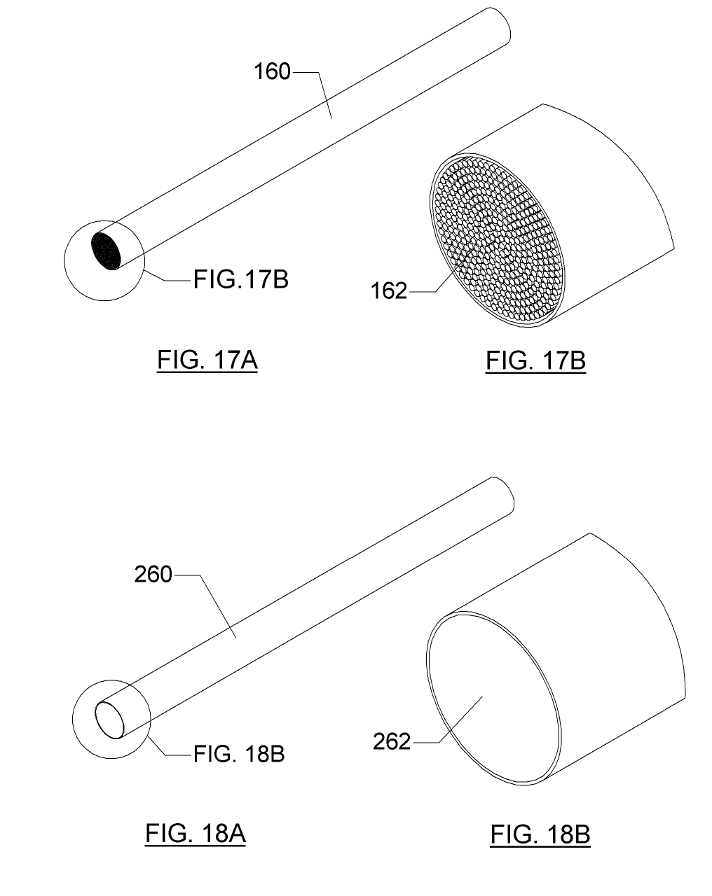

Referring to FIGS. 17A-B. Plastic optical fiber bundle 160 details a plurality of plastic optical fibers 162. Fiber bundle 160 is flexible and can be shaped into many forms without compromising the light transmission properties. Plastic optical fiber bundle 160 can be cut easily with a sharp knife or scissor without compromising light transmission properties.

Referring to FIGS. 18A-B. Plastic optical fiber 260 with single core 262 construction is shown. Light can be transmitted from one end to the other end in the same way it is done with the plastic optical fiber bundle. Plastic optical fiber 260 can be constructed from a rigid polycarbonate thermoplastic which can be permanently shaped with the application of heat eliminating the need for a guide. Plastic optical fiber 260 can also be constructed from a flexible material which would require the use of a guide.

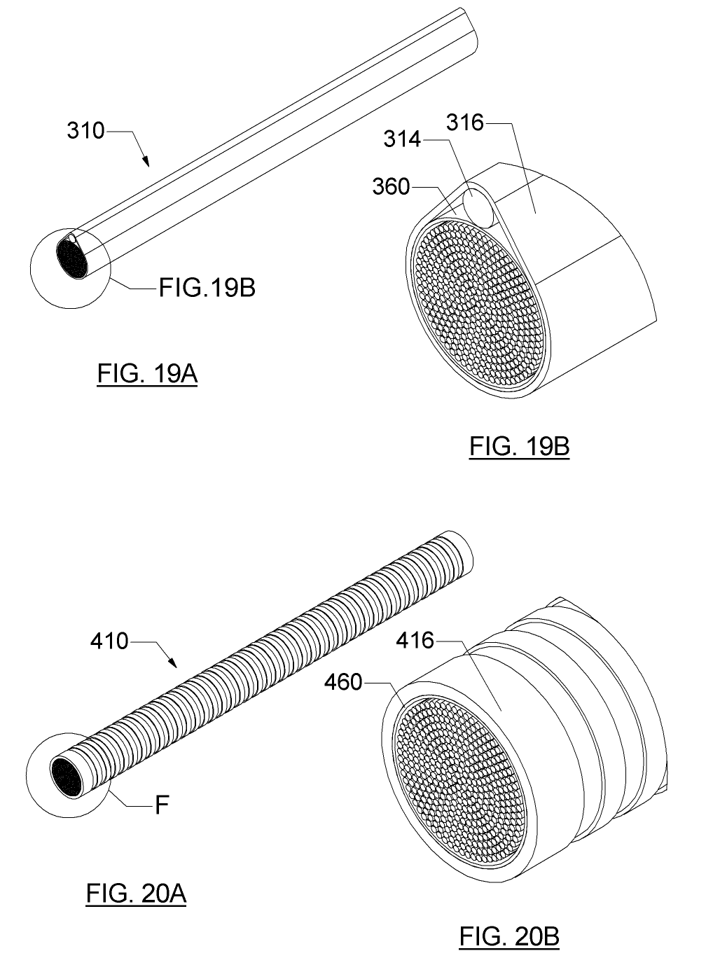

Referring to FIGS. 19A-B. Shrink wrapped assembly 310 contains a bendable metal wire 314 and a flexible fiber optic bundle 360 encased together with plastic shrink wrap 316. Shrink wrapped assembly 310 can be shaped into many forms by bending. Shaping shrink wrapped assembly 310 deforms bendable metal wire 314 maintaining a desired shape. As an alternative to using a flexible optical fiber bundle with a fixed guide, shrink wrapped assembly 310 is guided by shaping and positioning one end above the keypad surface to provide illumination.

Referring to FIGS. 20A-B. Flexible assembly 410 features a flexible plastic optical fiber bundle 460 encased in a flexible sheath 416. Flexible sheath 416 is typically manufactured from metal and sometimes coated with a layer of plastic shrink wrap for decorative purposes. Flexible sheathing is used in many applications including lamps to conceal electrical cords. Flexible sheath 416 can be used to guide one end of assembly 410 above the keypad surface face to provide illumination.

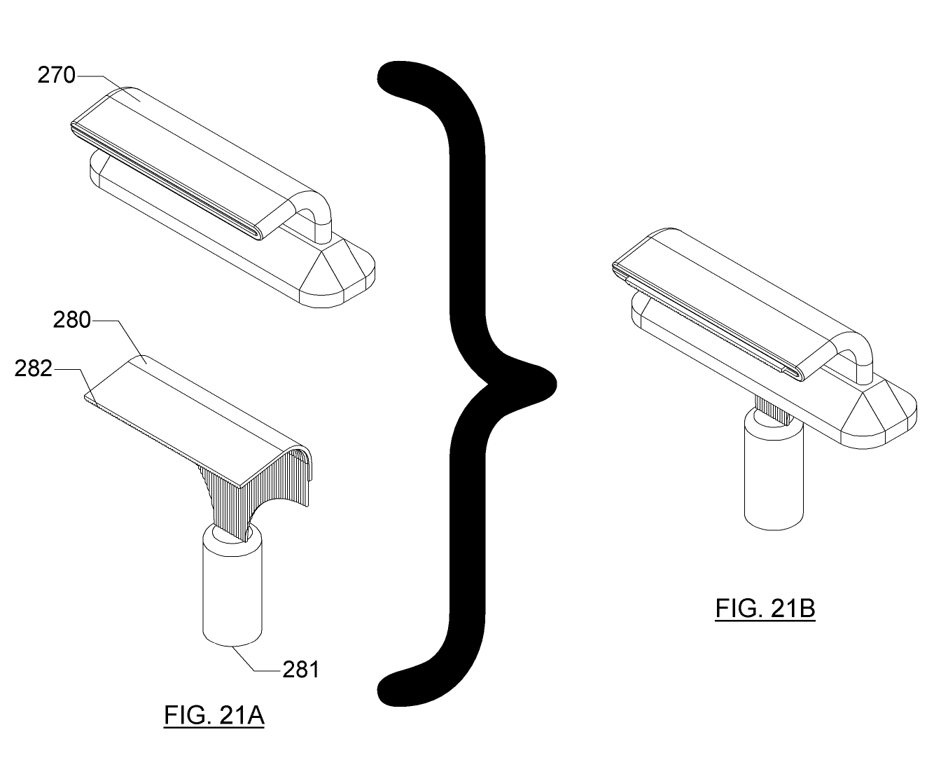

Referring to FIGS. 21A-B. Fiber ribbon 280 has a near end 281 and a far end 282. Far end 282 resembles a linear array of plastic optical fibers. Far end 282 is composed of a plurality of plastic optical fibers assembled in a linear array and is typically held together by an adhesive backed liner. Near end 281 more closely resembles both ends of the fiber optic bundle of the preferred embodiment. Guide 270 is used to retain flexible plastic optical fiber ribbon 280 properly and to orient far end 282 above the handheld remote control keypad to provide illumination.

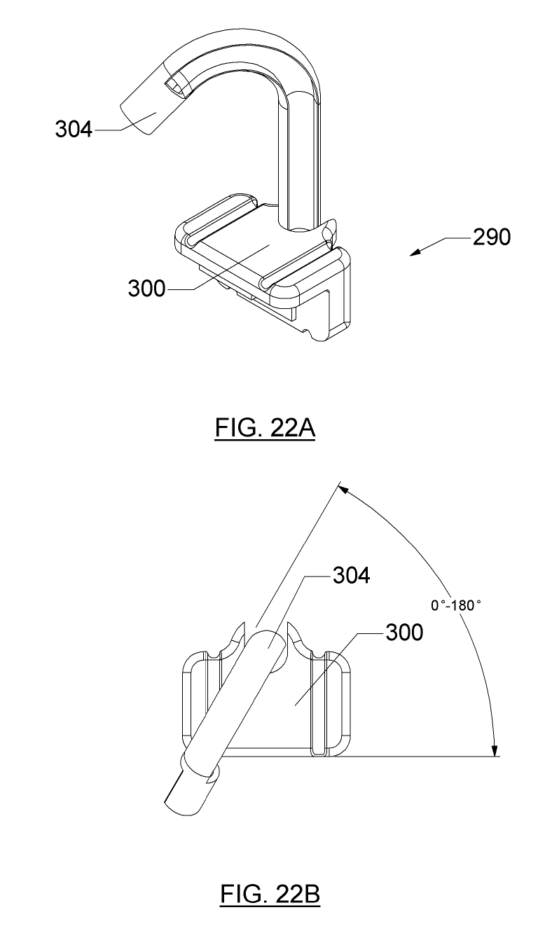

Referring to FIGS. 22A-B. Pivotal guide assembly 290 is composed of a fixed base 300 and a pivotal guide 304 and is an alternative to a fixed guide. Pivotal guide 304 of pivotal guide assembly 290 is rotated to provide a 180° range of illumination of the handheld remote control keypad. In all other respects pivotal guide assembly 290 functions the same way as the fixed guide of the preferred embodiment.

1. An illumination device for illuminating handheld remote control keypads comprising:
a housing assembly with a means for securing said housing assembly to said handheld remote control;
a light source disposed in said housing assembly with a means for controlling the operation of said light source;
an optical medium connected to said housing assembly, said optical medium having a near end, a length, and a far end, whereby said near end is positioned to capture light from said light source and said far end is positioned to illuminate said handheld remote control keypad; and
a guide for providing shape to said optical medium.

2. The illumination device of claim 1, wherein said optical medium has at least one curve, whereby said curve provides shape to said optical medium.

3. The illumination device of claim 1, wherein said optical medium is a plurality of optical fibers bundled together, wherein said bundle is round at said near end and round at said far end.

4. The illumination device of claim 1, wherein said optical medium is a plurality of optical fibers bundled together, wherein said bundle is round at said near end and flat said far end.

5. The illumination device of claim 1, wherein said optical medium is a single optical fiber, wherein optical fiber is round at said near end and round at said far end.

6. The illumination device of claim 5, wherein said single optical fiber is either rigid or flexible.

7. The illumination device of claim 1, wherein said guide is a flexible wire shrink wrapped with said optical medium, whereby said flexible wire provides shape to said optical medium.

8. The illumination device of claim 1, wherein said guide is a flexible sheath surrounding said optical medium, whereby said sheath provides shape to said optical medium.

9. The illumination device of claim 8, wherein said sheath is manufactured from metal or plastic.

10. The illumination device of claim 1, wherein said guide is a curved channel attached to said handheld remote control, whereby said channel provides shape and retention to said optical medium.

11. The illumination device of claim 10, wherein said curved channel includes a set of parallel grooves to guide an elastic band.

12. The illumination device of claim 10, wherein said curved channel pivots about a fixed base, wherein said fixed base is attached to said handheld remote control.

13. The illumination device of claim 12, wherein said fixed base includes a set of parallel grooves to guide an elastic band.

14. The illumination device of claim 1, wherein said light source is at least an LED, whereby said LED is coaxial with said optical medium.

15. The illumination device of claim 1, wherein said means for controlling the operation of said light source is by an electronic circuit contained within said housing assembly and connected to anode and cathode leads of said light source, said electronic circuit having a switch.

16. The illumination device of claim 15, wherein said electronic circuit includes:
a pair of identical 3 volt lithium coin cell batteries, said coin cell batteries axially spaced apart a distance which is greater than the diameter of said coin cell batteries, to establish left and right coin cell batteries, said left and right coin cell batteries having a flat anode surface, a flat cathode surface, and a cylindrical cathode surface, said flat cathode surface and said flat anode surface of said left and right coin cell batteries oriented parallel in the same direction and spaced apart by a distance, whereby said parallel flat cathode and flat anode surfaces of said left and right coin cell batteries contact anode and cathode leads respectively of said LED; and
a flexible metal conductive spring wire

17. The illumination device of claim 16, wherein said conductive spring wire contacts said flat anode surface of said left coin cell battery and said cylindrical cathode surface of said right coin cell battery, whereby illuminating the LED.

18. The illumination device of claim 1, wherein said means for securing said housing assembly to said handheld remote control is double sided adhesive foam tape.

19. The illumination device of claim 1, wherein said means for securing said housing assembly to said handheld remote control is hook and loop type fabric fasteners.

20. The illumination device of claim 1, wherein said housing assembly features a parallel set of grooves for retaining a tensioned elastic band.

21. The illumination device of claim 20, wherein said parallel set of grooves is spaced apart a distance equal to about the distance between rows of keys on said handheld remote control keypad.

22. The illumination device of claim 1, wherein said housing assembly features a tab for securing a looped and tensioned elastic band.

23. The illumination device of claim 1, wherein said means for securing said housing assembly to said handheld remote control is by looping an elastic band partially contained within said housing assembly around said handheld remote control.

24. The illumination device of claim 23, wherein said looped elastic band has a single 180° rotation thus creating a crossover point, whereby directing otherwise parallel members of said elastic band into a non-parallel configuration before and after said crossover point.
